(19) United States
(12) Patent Application Publication
(10) Pub. No.: US 2009/0109937 A1
(43) Pub. Date: Apr. 30, 2009

(54) SELECTING TRANSMISSION PARAMETERS FOR CONTENTION-BASED ACCESS IN WIRELESS SYSTEMS

(75) Inventors: Christopher R. Cave, Dollard-des-Ormeaux (CA); Paul Marinier, Brossard (CA); Benoit Pelletier, Roxboro (CA); Diana Pani, Montreal (CA); Rocco DiGirolamo, Laval (CA); Vincent Roy, Montreal (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/257,524

(22) Filed: Oct. 24, 2008

Related U.S. Application Data
(60) Provisional application No. 60/982,477, filed on Oct. 25, 2007.
(60) Provisional application No. 61/017,309, filed on Dec. 28, 2007.
(60) Provisional application No. 61/024,662, filed on Jan. 30, 2008.

(51) Int. Cl. H04W 74/00; H04W 72/00

(52) U.S. Cl. 370/336; 370/329

(57) ABSTRACT

A method and apparatus are disclosed for selecting a channel for uplink communication includes determining whether a cell supports transmission over an enhanced random access channel (E-RACH) and selecting whether to send uplink communications over the E-RACH or a random access channel. A method for selecting a transmission time interval (TTI) for use on an E-RACH includes evaluating radio conditions measured at a user equipment and selecting a long TTI if radio conditions are bad and selecting a short TTI if radio conditions are good. Alternatively, the TTI can be selected based on an amount of data to be transmitted on the uplink. A user equipment, an integrated circuit, or a Node B can be configured to perform either method.

### CROSS REFERENCE TO RELATED APPLICATIONS

This application claims the benefit of U.S. provisional Application No. 60/982,477, filed Oct. 25, 2007, U.S. provisional Application No. 61/017,309, filed Dec. 28, 2007 and U.S. provisional Application No. 61/024,662, filed Jan. 30, 2008, which are incorporated by reference as if fully set forth.

### FIELD OF INVENTION

The present invention is related to wireless communications.

### BACKGROUND

As part of the ongoing evolution of the Wideband Code Division Multiple Access (WCDMA) standard in 3GPP Release 8, a new work item was established to improve the performance of the uplink (UL) for wireless transmit receive units (WTRUs) in the CELL_FACH state. In Release 7 and earlier, the only uplink mechanism for IDLE, CELL_PCH, URA_PCH and CELL_FACH WTRUs is the Random Access Channel (RACH).

The RACH transport mechanism is based on a slotted-Aloha approach with an acquisition indication. Before sending a message, a WTRU tries to acquire the channel by sending a short preamble (made up of a randomly selected signature sequence) in a randomly selected access slot. The WTRU then listens/waits for an acquisition indication from the Universal Terrestrial Radio Access (UTRAN) on the acquisition indicator channel (AICH). This indication includes a specific AICH signature sequence mapped (one-to-one) to the preamble signature sequence chosen by the WTRU. If a positive acquisition indication is received, the WTRU has effectively acquired the channel and can transmit its message. The resources that the WTRU can use in the RACH case are pre-determined by the choice of the preamble signature sequence.

It has been proposed to use concepts similar to enhanced dedicated channel (E-DCH) to increase the data rate for CELL_FACH WTRUs in the definition of a new Enhanced RACH (or E-RACH). Specifically, it is proposed to use the E-DCH for UL transmission following the RACH pre-amble ramp-up, and AICH indication instead of using the Release 99 RACH to transmit the message. The E-DCH uses Hybrid Automatic Repeat Request (HARQ), fast Node B scheduling, as well as, high order modulations to achieve higher UL transmission rates.

For backward compatibility reasons, both the E-RACH and RACH coexist as contention-based access channels. As such, some WTRUs will select the E-RACH for UL transmissions while other WTRUs will select the RACH for UL transmissions. There currently exists no known mechanism or criteria for selecting one channel over the other.

Moreover, the WTRU may be capable of selecting between multiple parameter values when transmitting over E-RACH. One such parameter, the Transmission Time Interval (TTI), should be optimized to allow maximum scheduling flexibility while allowing WTRUs that perceive unfavorable channel conditions to successfully transmit medium access control (MAC) protocol data units (PDUs).

There currently exists no mechanism for a WTRU to select which RACH to use in a Release 8 network, and no mechanism for the WTRU to select the TTI in case the E-RACH is selected.

Accordingly, there exists a need for a method and apparatus for addressing these issues.

### SUMMARY

A method and apparatus for selecting a channel for uplink communication is disclosed. The method includes determining whether a cell supports transmission over an enhanced random access channel (E-RACH) and selecting whether to send uplink communications over the E-RACH or the RACH.

### BRIEF DESCRIPTION OF THE DRAWINGS

A more detailed understanding may be had from the following description, given by way of example in conjunction with the accompanying drawings wherein:

FIG. 1 shows an example wireless communication network having a plurality of NodeBs and WTRUs;

FIG. 2 shows an example functional block diagram of a Wireless Transmit Receive Unit (WTRU) configured to implement the disclosed method; and

FIG. 3 shows an example flow diagram of a disclosed method.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

The term enhance random access channel (E-RACH) (or Enhanced RACH) is used throughout the description to indicate a new contention-based access mechanism compared to the existing Release 99 RACH channel. The E-RACH includes the use of the enhanced dedicated channel (E-DCH) following pre-amble ramp, acquisition indication, or any other improvement to the 3GPP Release 99 RACH channel.

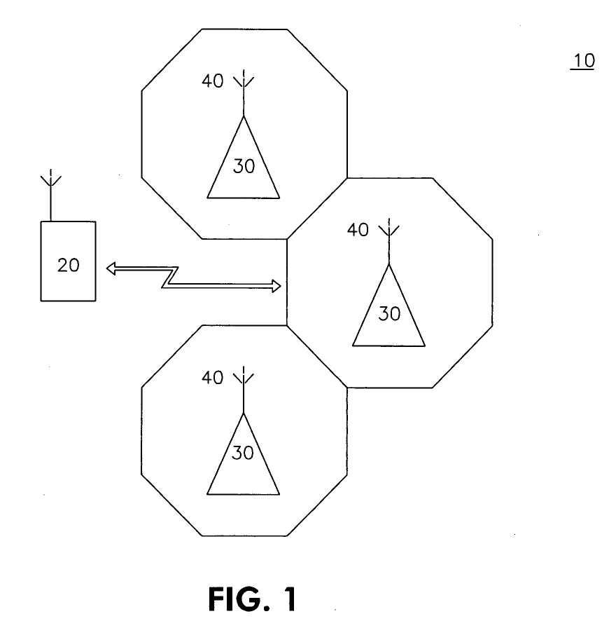

Referring to FIG. 1, a HSPA wireless communication network (NW) 10 comprises a WTRU 20, one or more Node Bs 30, and one or more cells 40. Each cell 40 comprises one or more Node Bs (NB or eNB) 30. WTRU 20 is configured to implement the method disclosed hereafter, for selecting between using a random access channel (RACH) and an enhanced RACH.

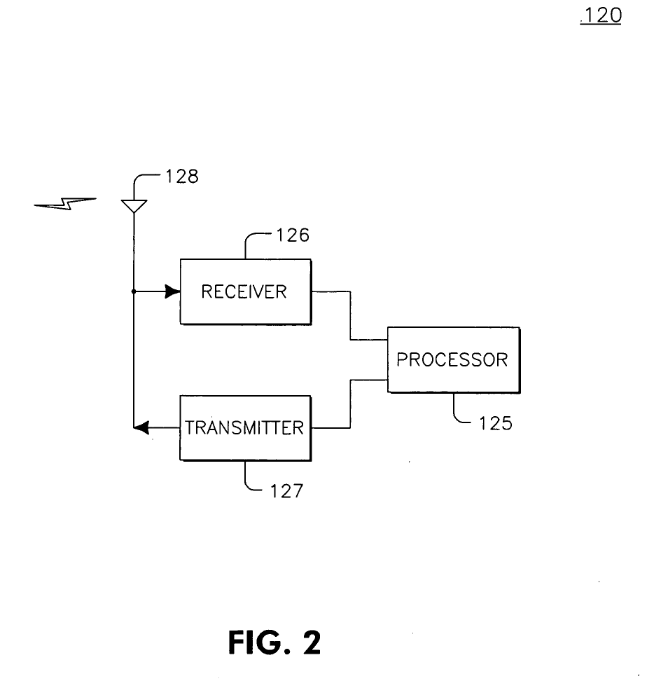

FIG. 2 is a functional block diagram of a transceiver 120 in a wireless system. In addition to components included in a typical transceiver, transceiver 120 includes a processor 125, configured to perform the method of channel selection as disclosed, receiver 126 in communication with processor 125, transmitter 127 in communication with processor 125, and antenna 128 in communication with receiver 126 and transmitter 127 to facilitate the transmission and reception of wireless data. Transceiver 120 is preferably a WTRU.

A method is disclosed wherein WTRU 120 autonomously selects a channel for uplink (UL) contention-based transmission. Accordingly, WTRU 120, upon selection of a new cell (e.g., upon power-up or after cell reselection), determines whether the cell supports transmission over E-RACH based on the information in the broadcast channel. A UTRAN, therefore, may broadcast in the broadcast channel (BCH) whether or not the cell supports E-RACH, as well as, parameters associated with E-RACH transmission, or E-RACH support is implicitly detected by the presence of E-RACH system information in the broadcast channel of the cell.

Alternatively, if the network is capable of controlling E-RACH capability dynamically on a per-cell basis (i.e., turning it on/off), the network may signal to WTRU 120 that the network is reconfiguring to/from E-RACH mode using an existing radio resource control (RRC) message. A new RRC message may also be used by the network.

If WTRU 120 determines that the cell supports E-RACH, WTRU 120 then selects whether to use the RACH or E-RACH for UL transmission based on one or more channel selection criteria. This channel selection criteria may be based on the logical channel for which data is to be transmitted. For example, common control channel (CCCH) and dedicated control channel (DCCH) signaling radio bearers (SRB0, SRB1, SRB2 and SRB3) may be sent over RACH while the dedicated traffic channel (DTCH) is sent over E-RACH. Alternatively, only the CCCH could be sent over RACH, while the DCCH and DTCH are sent over E-RACH.

Another channel selection criterion may be based on the medium access control (MAC) packet data unit (PDU) size to be transmitted. If the size of the MAC PDU is greater than Mbits, WTRU 120 may select the E-RACH for UL transmission. If the size of the MAC PDU is less than M bits, WTRU 120 selects the RACH for UL transmission.

Another criterion may be based on buffer occupancy at WTRU 120. As an example, if the buffer occupancy is greater than R bits, WTRU 120 selects the E-RACH for UL transmission. If the buffer occupancy is less than R bits, WTRU 120 selects the RACH for UL transmission. Channel selection may also be based on the WTRU RRC state. Accordingly, WTRU 120 may use the RACH when in IDLE mode, CELL_PCH state, or URA_PCH state and use the E-RACH when in CELL_FACH state. Alternatively, WTRU 120 may use the RACH in IDLE mode and use the E-RACH in CONNECTED mode (i.e., CELL_PCH, URA_PCH or CELL_FACH states).

The WTRU access class may also be included in the channel selection criteria. In accordance with this criterion, the UTRAN broadcasts which WTRU access classes are allowed to use the E-RACH. WTRU 120, therefore, selects the E-RACH if the E-RACH is available to its access class. Otherwise, WTRU 120 selects the RACH for transmission.

The WTRU-id may be used as a channel selection criterion. For example, if WTRU 120 has an E-RNTI assigned in CELL_FACH, then WTRU 120 can transmit using E-RACH in CELL_FACH. Otherwise, if no dedicated E-RNTI is assigned to WTRU 120, WTRU 120 may use the normal RACH UL transmissions. Alternatively, if WTRU 120 has no E-RNTI that has been assigned in CELL_FACH, WTRU 120 may use E-DCH to transmit common messages, such as CCCH messages, and the RACH to transmit messages from other logical channels, such as DCCH or DTCH.

Alternatively, if the WTRU does not have an E-RNTI due to cell reselection, WTRU 120 uses E-RACH to transmit the CELL_UPDATE. If no dedicated E-RNTI is assigned to WTRU 120 in the CELL_UPDATE CONFIRM, WTRU 120 transmits all subsequent UL messages or data using R99 RACH and optionally falls back to pre-R8 operations.

The channel selection may be based on HARQ statistics as well. For example, WTRU 120 may use the ratio of ACK-to-NACK of the previous E-RACH transmissions (in CELL_FACH) within a given past observation window. If the ratio is too low (too many NACKs) compared to a given threshold, then the radio conditions are considered bad and WTRU 120 is configured by the network to revert to Release 99 RACH or to E-DCH with smaller transport block sizes. The duration of the observation window and the threshold value can be signaled by higher layer or pre-configured.

Channel selection may be based on downlink (DL) channel quality as measured from the common pilot channel (CPICH) or some other downlink reference channel. WTRU 120 monitors the DL quality over some observation window, and may select the RACH over the E-RACH if conditions suggest a deterioration. For example, if the quality of a neighboring cell comes within X dB of the source cell, WTRU 120 selects the RACH over the E-RACH.

Traffic activity on the uplink and/or downlink may also be used for channel selection by processor 125. For example, if the traffic activity is high, WTRU selects the E-RACH. Traffic activity can be measured in terms of counts at the physical, MAC, and/or radio link control (RLC) layer.

Deterministic “E-RACH cycle,” specified by the network, may also be used for channel selection. In a scenario with many WTRUs in CELL_FACH, IDLE, CELL/URA_PCH, the network may wish to control the number of WTRUs using the E-RACH, and at the same time, maintain fairness across WTRUs. This E-RACH cycle can be signaled through L1, or L2/L3.

Channel selection may use the collision and/or blocking rates observed by WTRU 120 over a given observation window. For example, if WTRU 120, supporting E-RACH in CELL_FACH, is blocked a number of times over a given period of time (or number of consecutive accesses), WTRU 120 may revert to the RACH. The relevant parameters, (e.g., the allowed number of times to be blocked and the period of time) can be pre-defined or configured by the network. Likewise, if the collision rate is higher than a pre-defined or configured threshold, WTRU 120 would revert to RACH.

According to the disclosed method and apparatus, WTRU 120 selects the channel (RACH or E-RACH) during one or more of the following times; prior to every UL access in CELL_FACH state, CELL_PCH state, URA_PCH state and/or IDLE mode, upon transition to CELL_FACH state from any other state, upon transition from IDLE mode to CONNECTED mode, or upon cell selection and/or cell reselection while in CELL_FACH state, CELL_PCH state, URA_PCH state and/or IDLE mode.

In an alternate method, WTRU 120 is configured to always use E-RACH if WTRU 120 and the cell support enhanced RACH. For backwards compatibility purposes, it is preferable that WTRU 120 know the Serving Radio Network Controller (SRNC) capabilities (i.e., if it supports enhanced RACH). If the SRNC does not support E-RACH, WTRU 120 configures itself to send UL transmissions over the RACH.

The criteria and associated parameters for WTRU 120 selection of RACH or E-RACH may be configured by higher layers. As such, configuration information may be broadcast throughout the cell using Layer 3 (L3) messages over the broadcast control channel/broadcast channel (BCCH/BCH).

Alternatively, the criteria for channel selection can be pre-configured (e.g., explicitly specified by 3GPP specifications).

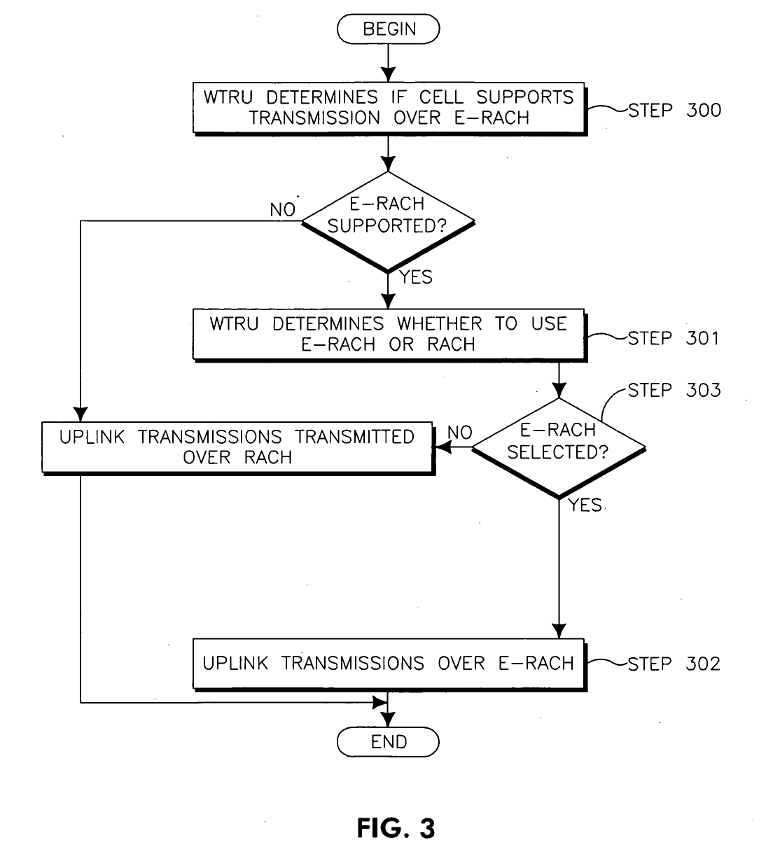

FIG. 3 shows an example flow diagram of the disclosed method used by WTRU 120 for selecting between the RACH and E-RACH. When WTRU 120 selects a new cell, WTRU 120 determines if the cell supports transmission over E-RACH (step 300). As disclosed above, the UTRAN may broadcast whether the cell supports E-RACH.

If the cell supports E-RACH, processor 125 of WTRU 120 determines whether to use RACH or E-RACH for uplink transmission (step 301) using the selection criteria disclosed above.

If processor 125 selects the E-RACH, uplink transmissions are transmitted over the E-RACH (step 302) at least until WTRU 120 is required to again select between the RACH and E-RACH channels as configured. Otherwise, uplink transmissions are transmitted over the RACH (step 303) until WTRU 120.

A method for selecting the Transmission Time Interval (TTI) for transmission over the E-RACH is disclosed, wherein WTRU 120 autonomously selects the TTI parameter for transmission over the E-RACH. In accordance with this disclosed method, in cells where multiple TTI values are allowed for UL transmission, e.g. 2 ms and 10 ms, WTRU 120 selects a TTI based on the radio conditions measured at WTRU 120. When radio conditions are bad, WTRU 120 may use the longer TTI (e.g., 10 ms). When radio conditions are good, WTRU 120 may use the shorter TTI (e.g., 2 ms).

Processor 125 of WTRU 120 determines the quality of the radio conditions using one or more measurements including, the received signal power measured on one or more downlink control channels (e.g., CPICH), the Signal-to-Noise Ratio measured on one or more downlink control channels (e.g., CPICH), and physical random access channel (PRACH) propagation delay. For the PRACH propagation delay measurement, if the measurement is longer than a certain threshold signaled by the network or pre-defined, the radio conditions are considered bad.

The ratio of ACK-to-NACK of the previous enhanced dedicated channel (E-DCH) transmissions (in CELL_FACH) within a given past observation window may also be included in the measurements made by WTRU 120 to determine the quality of the radio conditions. If the ratio is too low (too many NACKs) compared to a given threshold, then the radio conditions are considered bad. The duration of the observation window and the threshold value can be signaled by higher layer or pre-configured.

Alternatively, the TTI may be selected by WTRU 120 based on the amount of data to be transmitted in the UL and based on the priority of the data to be transmitted (i.e., higher priority data could use the shorter 2 ms TTI).

The logical channel that is being transmitted may also be used to select the TTI, or selected based on the Access Service Class. For example, a TTI of 10 ms could be selected when transmitting CCCH while a TTI of 2 ms could be selected when transmitting DTCH.

The methods disclosed above can be expanded to the selection of other E-RACH or RACH transmission parameters as well, for example, the set of available signatures and the set of available RACH sub-channels, parameters related to the transmission of preambles, (e.g., maximum number of preamble ramping cycles, allowed time intervals between two preamble ramping cycles, power-ramping factors, preamble retransmission parameters and the initial preamble power).

Another example of RACH or E-RACH parameters are back off parameters (N_{BO1min} and N_{BO1max}), the message length (RACH), acquisition indicator channel (AICH)-related parameters (e.g., AICH_Transmission_Timing parameter), parameters related to setting the power of the message part (e.g., power offset P p-m) and the set of transport format parameters, including the power offset between the data part and the control part of the random-access message for each transport format.

When WTRU 120 autonomously selects the TTI value, WTRU 120 signals this value to a Node B by signaling the TTI selection on first transmission. This may be achieved using layer 1 (L1) or layer 2 (L2) signaling. For example, a special field may be included in an existing field re-interpreted in the enhanced dedicated physical control channel (E-DPCCH) or in the MAC header to indicate the TTI selection for the remaining transmissions or re-transmissions from WTRU 120.

Alternatively, the TTI value may be implicitly signaled using a subset of the available signatures and available RACH sub-channels reserved for the selected TTI value. For example, the Node B may signal which access service class (ASC) is reserved for each TTI value (i.e., 2 ms or 10 ms) on the broadcast channel. Therefore, the 2 ms TTI value can be reserved to certain access classes, for instance.

In an alternate method, blind detection of the TTI selection by the Node B could be used. In this case, WTRU 120 would not need to signal its TTI selection value at all.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method for selecting a channel for uplink communication, comprising:
determining whether a cell supports transmission over an enhanced random access channel (E-RACH);
selecting whether to send uplink communications over the E-RACH or a random access channel (RACH).

2. The method of claim 1, wherein the determining step is performed upon selection of a new cell.

3. The method of claim 1, wherein the determining step includes receiving a transmission by the network whether or not the cell supports the E-RACH.

4. The method of claim 3, wherein the transmission by the network includes parameters associated to the E-RACH transmission.

5. The method of claim 1, wherein the channel selection criteria includes the size of a medium access control (MAC) protocol data unit (PDU) to be transmitted.

6. The method of claim 5, wherein if the MAC PDU is greater than a predetermined size, then the E-RACH is selected.

7. The method of claim 1, wherein the selection criteria base includes a buffer occupancy value.

8. The method of claim 7, wherein if the buffer occupancy value is greater than a predetermined value, then the E-RACH is selected.

9. The method of claim 1, wherein the channel selection criteria includes a radio resource control (RRC) state of a wireless transmit receive unit (WTRU).

10. The method according to claim 9, wherein the UE uses the RACH when in Idle mode, CELL_PCH state, or URA_PCH state and uses the E-RACH when in CELL_FACH state.

11. The method according to claim 10, wherein the UE uses the RACH when in Idle mode and uses the E-RACH when in Connected mode.

12. The method of claim 1, wherein the channel selection criteria includes an access class.

13. The method of claim 12, further comprising:
receiving a network broadcast including access classes allowed to use the E-RACH; and
selecting the E-RACH if the E-RACH is available to a certain access class.

14. The method of claim 1, further comprising selecting a transmission time interval (TTI) for use on the E-RACH.

15. The method of claim 14, wherein the selection of the TTI comprises:
measuring radio conditions;
if radio conditions are equal to or above a predetermined threshold, then a long TTI is selected; and
if radio conditions are less than a predetermined threshold, then a short TTI is selected.

16. The method of claim 15, wherein the long TTI is 10 ms and the short TTI is 2 ms.

17. The method of claim 16 further comprising signaling the selected TTI value to a Node B.

18. The method of claim 17, wherein the TTI selection is explicitly signaled on a first uplink transmission.

19. The method of claim 17, wherein the transmission is Layer 1 or Layer 2 signaling.

20. The method of claim 17, wherein the TTI selection is implicitly signaled by using a subset of available signatures and available random access channel sub-channels reserved for the selected TTI value.

21. The method of claim 17, wherein the selected TTI value is blind detected at the Node B.

22. A wireless transmit receive unit (WTRU) comprising:
a receiver for receiving communications; and
a processor for selecting a channel for uplink transmission, wherein an enhanced random access channel (E-RACH) is selected for uplink transmission based on a channel selection criteria.

23. The WTRU of claim 22, wherein the receiver receiving a communication including whether or not the cell supports E-RACH.

24. The WTRU of claim 23, wherein the received communication includes parameters associated with the E-RACH.

25. The WTRU of claim 24, wherein the channel selection criteria includes the size of a medium access control (MAC) protocol data unit (PDU) to be transmitted.

26. The WTRU of 25, wherein if the MAC PDU is greater than a predetermined size, then the E-RACH is selected.

27. The WTRU of claim 22, wherein the channel selection criteria includes a buffer occupancy value.

28. The WTRU of claim 28, wherein if the buffer occupancy value is greater than a predetermined value, then the E-RACH is selected.

29. The WTRU of claim 22, wherein the channel selection criteria includes a radio resource control (RRC) state.

30. The WTRU according to claim 29, wherein the RACH is selected when the WTRU is in Idle mode, CELL_PCH state, or URA_PCH state, and the E-RACH is selected when the WTRU is in CELL_FACH state.

31. The WTRU according to claim 30, wherein the RACH is used when in Idle mode, and the E-RACH is used when in Connected mode.

32. The WTRU of claim 22, wherein the channel selection criteria includes an access class.
